(19) United States
(12) Patent Application Publication
(10) Pub. No.: US 2022/0063197 A1
(43) Pub. Date: Mar. 3, 2022

(54) Method For Bonding Three-Dimensional Articles Made By Additive Manufacturing

(71) Applicant: Henkel IP & Holding GmbH, Dusseldorf (DE)

(72) Inventors: Raymond Tully, Slane (IE); Rory Barnes, Dublin (IE); David Mullin, Navan (IE); Nigel Sweeney, Terenure (IE); Rachel Hersee, Drimnagh (IE)

(21) Appl. No.: 17/454,139

(22) Filed: Nov. 9, 2021

Related U.S. Application Data
(63) Continuation of application No. PCT/EP2020/060921, filed on Apr. 17, 2020.

(30) Foreign Application Priority Data
May 10, 2019 (GB) 1906640.6

(51) Int. Cl. B29C 64/30; B33Y 80/00; B33Y 70/00; B33Y 40/20; C08F 2/50; C08J 5/12; C09J 133/08; C09J 133/10; C08K 5/17; C08K 5/098; C08F 222/10

(52) U.S. Cl. CPC B29C 64/30; B33Y 80/00; B33Y 70/00; B33Y 40/20; C08F 2/50; C08F 222/102; C09J 133/08; C09J 133/10; C08K 5/17; C08K 5/098; C08J 5/124

(57) ABSTRACT

A method of bonding a substrate comprising a three-dimensional printed article to another substrate, by activating the three-dimensional printed article is described, thereby facilitating bonding of the two substrates using redox curable adhesives, for example anaerobically curable adhesives.

### BACKGROUND

### Field

Provided herein are methods for bonding three-dimensional articles made by additive manufacturing, in particular a method for bonding a substrate comprising a three-dimensional printed article to another substrate is provided. Also provided herein is a photocurable composition for use in three-dimensional printing.

### Brief Description of Related Technology

Additive manufacturing is fast becoming a viable alternative to traditional manufacturing techniques and in some cases the only practical alternative for making complex parts.

Additive manufacturing and three-dimensional printing in particular have become mainstream methods for developing prototypes efficiently. The ability to produce complex materials quickly and cost effectively is highly desirable. While the manufacture of complex materials can sometimes be achieved entirely by three-dimensional printing, in some cases assembly of component parts which have been manufactured using three-dimensional printing into a complex product is required.

While the bonding of active substrates such as metals can be readily achieved using redox curable adhesives, the bonding of metal substrates to plastics can be more difficult. Furthermore, the bonding of two inactive plastic/polymeric substrates can be very challenging. In order to effect the bonding of for example a metal substrate to an inactive plastic substrate, or alternatively to effect the bonding of two plastic/polymeric substrates primers may be used in conjunction with anaerobically curable adhesives.

Where bonding of two substrates is required, primer may be applied to at least one of the substrates. So, for example, when bonding two substrates together, where at least one of those substrates is a difficult to bond substrate, primer may be applied to either substrate, though desirably it is applied to the difficult to bond substrate.

Primers are particularly useful for improving the bonding of anaerobically curable adhesives.

Anaerobically curable compositions generally are well known. See e.g. R. D. Rich, “Anaerobic Adhesives” in Handbook of Adhesive Technology, 29, 467-79, A. Pizzi and K. L. Mittal, eds., Marcel Dekker, Inc., New York (1994), and references cited therein. Their uses are legion and new applications continue to be developed.

Anaerobic adhesive systems are those which are stable in the presence of oxygen, but which polymerize in the absence of oxygen. Polymerization is initiated by the presence of free radicals, often generated from peroxy compounds. Anaerobic adhesive compositions are well known for their ability to remain in a liquid, unpolymerized state in the presence of oxygen and to cure to a solid state upon the exclusion of oxygen.

Oftentimes anaerobic adhesive systems comprise resin monomers terminated with polymerizable acrylate ester such as methacrylate, ethylacrylate and chloroacrylate esters [e.g., polyethylene glycol dimethacrylate and urethane-acrylates (e.g., U.S. Pat. No. 3,425,988 (Gorman)] derived according to known urethane chemistry. Other ingredients typically present in anaerobically curable adhesive compositions include initiators, such as an organic hydroperoxide for example cumene hydroperoxide, tertiary butyl hydroperoxide and the like, accelerators to increase the rate at which the composition cures, and stabilizers such as quinone or hydroquinone, which are included to help prevent premature polymerization of the adhesive due to decomposition of peroxy compounds.

Desirable cure-inducing compositions to induce and accelerate anaerobic cure may include one or more of saccharin, toluidines, such as N,N-diethyl-p-toluidine (“DE-p-T”) and N,N-dimethyl-o-toluidine (“DM-o-T”), and acetyl phenyl hydrazine (“APH”) with maleic acid. See e.g. U.S. Pat. No. 3,218,305 (Krieble), U.S. Pat. No. 4,180,640 (Melody), U.S. Pat. No. 4,287,330 (Rich) and U.S. Pst. No. 4,321,349 (Rich).

Saccharin and APH are used as standard cure accelerator components in anaerobic adhesive cure systems. Indeed, many of the LOCTITE⁸-brand anaerobic adhesive products currently available from Henkel Corporation use either saccharin alone or both saccharin and APH.

Anaerobically curable adhesive compositions also commonly include chelators such as ethylenediamine tetraacetic acid (EDTA) which are employed to sequester metal ions.

It is known that anaerobic adhesives cure more rapidly when a metallic surface to which the adhesive is applied has been pre-treated with a primer activator, such as a transition metal salt which will catalyse the polymerization of the anaerobically curable monomer.

Typically, a primer activator composition comprises one or more activator components in a solvent or mixture of solvents. To facilitate the production process, the solvent or mixture of solvents should be readily evaporated.

Anaerobic adhesives are primarily used to bond metal to metal parts, however, for bonding substrates having inactive surfaces such as plastics, primer compositions are used. Primers are generally applied by wiping the surface to be bonded with a primer composition, or spraying a primer composition onto the surface. In such application processes, the solvent readily evaporates leaving the primed surface behind ready for application of an adhesive.

As industry moves towards more sustainable and environmentally friendly systems, reducing the use of solvent based primers is viewed as desirable.

International patent application publication no. WO2017121824 (Houlihan) describes a bonding system for bonding a plastic substrate to another substrate, the bonding system comprising a plastic substrate wherein the plastic substrate is impregnated with a transition metal; and an anaerobically curable composition. Cure of the anaerobically curable composition is initiatable by the transition metal impregnated in the plastic substrate when the anaerobically curable composition is contacted with the plastic substrate under anaerobic conditions. Plastic materials cannot be impregnated by application of a material such as a liquid material to the substrate. Application of a material such as a liquid material to a plastics substrate results in a layer on the surface. A surface layer is not considered to be impregnation. Furthermore, a plastics substrate cannot be impregnated by application of a liquid material whether or not an applied vacuum is utilised. Plastics substrates are not porous and use of a vacuum will not effect impregnation. Accordingly, impregnation of a plastic substrate with a transition metal is achieved by adding a transition metal component (e.g. copper (II) acetyl acetonate) to pellets of the plastic, followed by melting of the plastic pellets and subsequent molding of the mixture comprising the melted plastic and the transition metal component. Thus, a thermoplastic polymeric material is melted in the presence of a transition metal, and the resulting mixture is subsequently molded to form a plastic substrate impregnated with the transition metal.

Notwithstanding the state of the art it would be desirable to provide a method for bonding three-dimensional articles made by additive manufacturing, in particular method for bonding a substrate comprising a three-dimensional printed article to another substrate. Also provided herein is a photocurable composition for use in three-dimensional printing.

### SUMMARY

In one aspect, the present invention provides a method of bonding a substrate comprising a three-dimensional printed article to another substrate, the method comprising the steps of:
providing a substrate comprising a three-dimensional printed article;
wherein said three-dimensional printed article is formed by photocuring a photocurable composition comprising:
a photopolymerizable component,
a photoinitiator, and
a transition metal;
applying a redox curable composition to one of said substrates; and
mating together the two substrates for a time sufficient for cure of the redox curable composition to take place.

Advantageously, the present invention facilitates bonding of three-dimensional printed articles to other substrates, including plastic substrates, and indeed other three- dimensional printed articles, to form bonded assemblies. The method of the present invention may be employed for example to form complex products from three-dimensional printed articles. The method of the present invention provides significant advantages over prior art methods for forming such bonding assemblies, as the method facilitates bonding of three-dimensional printed articles.

In the method of the present invention the transition metal may be any transition metal selected from Groups 3 to 12 of the Periodic Table of Elements and combinations thereof. For example, a salt of any transition metal selected from Groups 3 to 12 of the Periodic Table of Elements, and combinations of those salts, may be used.

In all cases however it will be appreciated that the transition metal is redox active. Being redox active allows it to participate in the activation (cure) of redox curable compositions, such as an anaerobically curable composition.

The transition metal may be present in the form of a salt.

The transition metal may be titanium, chromium, manganese, iron, cobalt, nickel, copper, zinc, silver, vanadium, molybdenum, ruthenium, and combinations thereof.

The transition metal may be present in the photocurable composition in a mass fraction amount of from about 30 ppm to about 1000 ppm. Suitably, the transition metal may be present in the photocurable composition in a mass fraction amount of from about 50 ppm to about 750 ppm, for example from about 50 ppm to about 500 ppm.

Suitably, the redox curable composition comprises a (meth)acrylate adhesive composition.

The redox curable composition may comprise an anaerobically curable composition.

The photocurable composition may further comprises an amine component. Suitably, the amine component comprises a trialkyl amine, for example R₃N, where R is C₁-C₁₂ alkyl.

The amine component may be present in a mass fraction amount of from about 15 ppm to about 1000 ppm, for example in a mass fraction amount from about 20 ppm to about 1000 ppm, for example in a mass fraction amount from about 15 ppm to about 500 ppm.

When the amine component is present the transition metal component is suitably present in an amount of from about 50 ppm to about 150 ppm.

The photopolymerizable component may comprise one or more (meth)acrylate monomer components.

The (meth)acrylate monomer suitably has the formula: H₂C═CGCO2R¹, wherein G may be hydrogen, halogen or alkyl groups having from 1 to about 4 carbon atoms, and R¹ may be selected from alkyl, cycloalkyl, alkenyl, cycloalkenyl, alkaryl, aralkyl or aryl groups having from 1 to about 16 carbon atoms, any of which may be optionally substituted or interrupted as the case may be with silane, silicon, oxygen, halogen, carbonyl, hydroxyl, ester, carboxylic acid, urea, urethane, polyurethane, carbonate, amine, amide, sulfur, sulfonate, and sulfone.

Suitably, the time sufficient for cure of the redox curable composition is 15 minutes or less, for example, 10 minutes or less or 5 minutes or less, such as 4 minutes or less, 3 minutes or less, 2 minutes or less, or 1 minute or less.

In another aspect the present invention provides, a photocurable composition comprising:
a photopolymerizable component,
a photoinitiator,
a transition metal; and
an amine;
wherein the transition metal is present in a mass fraction amount of from about 30 ppm to about 1000 ppm based on the total mass of the photocurable composition; and wherein the amine is present in a mass fraction amount of from about 15 ppm to about 1000 ppm based on the total mass of the photocurable composition, for example in a mass fraction amount from about 15 ppm to about 500 ppm, for example in a mass fraction amount from about 20 ppm to about 1000 ppm.

Suitably, the amine is a trialkyl amine having the formula R₃N, where each R is a C₁-C₁₂ alkyl group. For example, the trialkyl amine may be selected from the group consisting of triethylamine, tripropylamine, tributylamine, tripentylamine, and trihexylamine.

Surprisingly, the addition of the amine in the presence of the transition metal augments the activation effect and shorter fixture times can be achieved.

The shortest fixture times were achieved, when an amine was present in a mass fraction of from about 20 ppm to about 150 ppm, and the transition metal was present in a mass fraction amount of from about 30 ppm to about 100 ppm.

The three-dimensional printed article may comprise a polymer formed by polymerisation of at least one (meth)acrylate monomer selected from beta-carboxy ethyl acrylate, isobornyl acrylate, cyclohexyl acrylate, tetrahydrofurfuryl acrylate, 2-ethylhexyl acrylate, ethoxyethoxyethyl acrylate, hydroxyethyl acrylate, hydroxypropyl acrylate, ethylene glycol diacrylate, diethylene glycol diacrylate, dipropylene glycol diacrylate, triethylene glycol diacrylate, tetraethylene glycol diacrylate, 1,6-hexane diol diacrylate, (5-ethyl-1,3-dioxan-5-yl)methyl acrylate tripropylene glycol diacrylate, (octahydro-4,7-methano-1Hindenediyl)bis(methylene) diacrylate, glycerol triacrylate, trimethylol propane diacrylate, trimethylol propane triacrylate, isobornyl methacrylate, tri methylolpropane trimethacrylate, ethylene glycol dimethacrylate, diethylene glycol dimethacrylate, 1,6-hexanediol dimethacrylate, hydroxybutyl methacrylate, tetrahydrofurfuryl methacrylate, cyclohexyl methacrylate, phenoxyethyl methacrylate, poly(ethylene glycol) methacrylate.

### DETAILED DESCRIPTION

As noted above, the present invention provides a method of bonding a substrate comprising a three-dimensional printed article to another substrate, the method comprising the steps of:
(a) providing a substrate comprising a three-dimensional printed article;
wherein said three-dimensional printed article is formed by photocuring a photocurable composition comprising:
(i) a photopolymerizable component,
a photoinitiator, and
a transition metal;
(b) applying a redox curable composition to at least one of said substrates; and
(c) mating together the two substrates for a time sufficient for cure of the redox curable composition to take place.

Thus, the three-dimensional printed article in step (a) is bonded to another substrate using a redox curable composition. The redox curable composition may be applied to one or both substrates. The two substrates are mated together for a time sufficient for cure of the redox curable composition to take place.

The redox curable composition is an adhesive composition, such as an anaerobically curable adhesive composition, for example an anaerobically curable (meth)acrylate adhesive composition.

The redox curable composition may for example cure in 15 minutes or less, for example 10 minutes or less, such as 5 minutes or less, preferably 3 minutes or less, most preferably 2 or 1 minute or less.

The redox curable composition may for example cure at 23° C., and a relative humidity of 50% in less than 3 minutes. Suitably, the redox curable composition cures under ambient conditions.

### Photopolymerisable Component

The photopolymerizable component may comprise at least one (meth)acrylate monomer.

The at least one (meth)acrylate monomer may be selected from beta-carboxy ethyl acrylate, isobornyl acrylate, n-octyl acrylate, n-decyl acrylate, cyclohexyl acrylate, tetrahydrofurfuryl acrylate, 2-ethylhexyl acrylate, ethoxyethoxyethyl acrylate, ethoxylated phenyl monoacrylate, hydroxyethyl acrylate, hydroxypropyl acrylate, hydroxybutyl acrylate, isooctyl acrylate, n-butyl acrylate, neopentyl glycol diacrylate, ethylene glycol diacrylate, diethylene glycol diacrylate, dipropylene glycol diacrylate, triethylene glycol diacrylate, tetraethylene glycol diacrylate, 1,6-hexane diol diacrylate, tripropylene glycol diacrylate, glycerol triacrylate, trimethylol propane diacrylate, trimethylol propane triacrylate, pentaerythritol tetraacrylate, phenoxyethyl acrylate, hydroxyethyl methacrylate, hydroxypropyl methacrylate, cyclohexyl methacrylate, glycerol mono-methacrylate, glycerol 1,3-dimethacrylate, trimethyl cyclohexyl methacrylate, methyl triglycol methacrylate, isobornyl methacrylate trimethylolpropane trimethacrylate, neopentyl glycol dimethacrylate, ethylene glycol dimethacrylate, diethylene glycol dimethacrylate, 1,6-hexanediol dimethacrylate, hydroxybutyl methacrylate, tetrahydrofurfuryl methacrylate, cyclohexyl methacrylate, phenoxyethyl methacrylate, poly(ethylene glycol) methacrylate and mixtures thereof.

Suitably, the photopolymerisable composition may comprise a photocurable (meth)acrylate composition comprising one or more of (5-ethyl-1,3-dioxan-5-yl)methyl acrylate tripropylene glycol diacrylate, (Octahydro-4,7-methano-1Hindenediyl)bis(methylene) diacrylate, trimethylolpropane triacrylate and isobornyl methacrylate.

Preferably, the photopolymerisable composition comprises a photocurable (meth)acrylate composition comprising (Octahydro-4,7-methano-1Hindenediyl)bis(methylene) diacrylate.

### Photoinitiator

One or more free radical photoinitiators can be included in the radiation curable composition. Suitable photoinitiators are active in the UV/visible range, approximately 250-850 nm, or some segment thereof. More suitably, the photoinitiators used in the present invention are active in the UV/visible range, approximately 250-850 nm, and preferably in the range of 300 to 450 nm so that the compositions can be cured by exposure to low intensity UV. Examples of photoinitiators, which initiate under a free radical mechanism, include benzoyl peroxide, benzophenone, acetophenone, chlorinated acetophenone, dialkoxyacetophenones, dialkylhydroxyacetophenones, dialkylhydroxyacetophenone esters, benzoin, benzoin acetate, benzoin alkyl ethers, dimethoxybenzoin, dibenzylketone, benzoylcyclohexanol and other aromatic ketones, acyloxime esters, acylphosphine oxides, acylphosphosphonates, ketosulfides, dibenzoyldisulphides, diphenyldithiocarbonate and diphenyl(2,4,6-trimethylbenzoyl) phosphine oxide. Other examples of photoinitiators that may be used in the photocurable compositions of the present invention include photoinitiators available commercially from Ciba Specialty Chemicals, Tarrytown, N.Y., under the IRGACURE® and DAROCUR® tradenames, for example IRGACURE® 184 (1-hydroxycyclohexyl phenyl ketone), 907 (2-methyl-1-[4-(methylthio)phenyl]-2-morpholino propan-1-one), 369 (2-benzyl-2-N,N-dimethylamino-1-(4-morpholinophenyI)-1-butanone), 500 (the combination of 1-hydroxy cyclohexyl phenyl ketone and benzophenone), 651 (2,2-dimethoxy-2-phenyl acetophenone), 1700 (the combination of bis(2,6-dimethoxybenzoyl-2,4-,4-trimethyl pentyl phosphine oxide and 2-hydroxy-2-methyl-1-phenyl-propan-1-one) and DAROCUR® 1173 (2-hydroxy-2-methyl-1-phenyl-1-propane) and 4265 (the combination of 2,4,6-trimethylbenzoyldiphenyl-phosphine oxide and 2-hydroxy-2-methyl-1-phenyl-propan-1-one); and the visible light [blue] photoinitiators, dl-camphorquinone and IRGACURE® 784DC, or mixtures thereof.

In some embodiments, the photoinitiator comprises IRGACURE® 2959 (1-[4-(2-hydroxyethoxy)-phenyl]-2-hydroxy-2-methyl-1-propane-1-one). In some embodiments, the photoinitiator comprises DAROCUR® 4265, which consists of 50 wt % of DAROCUR® TPO (diphenyl (2,4,6-trimethylbenzoyl) phosphine oxide) and 50 wt % of DAROCUR® 1173 (2-hydroxy-2-methyl-1-phenyl-1-propanone), and which is commercially available from Ciba Specialty Chemicals.

Other useful photoinitiators include ultraviolet photoinitiators, such as 2,2-dimethoxy-2-phenyl acetophenone (e.g., IRGACURE® 651), and 2-hydroxy-2-methyl-1-phenyl-1-propane (e.g., DAROCUR® 1173) and the ultraviolet/visible photoinitiator combination of bis(2,6-dimethoxybenzoyl-2,4,4-trimethylpentyl)phosphine oxide and 2-hydroxy-2-methyl-1-phenyl-propan-1-one (e.g., IRGACURE® 1700), as well as the visible photoinitiator bis(η<5>-2,4-cyclopentadien-1-yl)-bis[2,6-difluoro-3-(1H-pyrrol-1-yl)phenyl]titanium (e.g., IRGACURE® 784DC). LUCIRIN® TPO, from BASF is another useful photoinitiator. Typically, the photoinitiators can be used in an amount of 0.05 to 5 weight percent, or 0.5 to 5 weight percent of the composition.

### Transition Metal

Desirably the transition metal may be copper, iron, vanadium, cobalt and chromium, and combinations thereof.

Desirably the transition metal is provided in the form of a salt.

Suitable salts include the following salts and any combination thereof.

Titanium salts include: titanium(IV) bromide; titanium carbonitride powder, Ti₂CN; titanium(II) chloride; titanium(III) chloride; titanium(IV) chloride; titanium(III) chloride-aluminum chloride; titanium(III) fluoride; titanium(IV) fluoride; titanium(IV) iodide; titanium(IV) oxysulfate solution

Chromium salts include: chromium(II) chloride; chromium(III) bromide; chromium(III) chloride; chromium(III) chloride tetrahydrofuran complex; chromium(III) fluoride; chromium(III) nitrate; chromium(III) perchlorate; chromium(III) phosphate; chromium(III) sulfate; chromyl chloride; CrO₂; potassium chromium(III) oxalate;

Manganese salts include: manganese(II) bromide; manganese(II) carbonate; manganese(II) chloride; manganese(II) cyclohexanebutyrate; manganese(II) fluoride; manganese(III) fluoride; manganese(II) formate; manganese(II) iodide; manganese(II) molybdate; manganese(II) nitrate; manganese(II) perchlorate; manganese(II) sulfate.

Iron salts include: ammonium iron(II) sulfate; iron(II) bromide; iron(III) bromide; iron(II) chloride; iron(III) chloride; iron(III) citrate; iron(II) fluoride; iron(III) fluoride; iron(II) iodide; iron(II) molybdate; iron(III) nitrate; iron(II) oxalate; iron(III) oxalate; iron(II) perchlorate; iron(III) phosphate; iron(III) pyrophosphate; iron(II) sulfate; iron(III) sulfate; iron(II) tetrafluoroborate; potassium hexacyanoferrate(II).

Cobalt salts include: cob1alt (II) naphthenate; Ammonium cobalt(II) sulfate; cobalt(II) benzoylacetonate; cobalt(II) bromide; cobalt(II) carbonate; cobalt(II) chloride; cobalt(II) cyanide; cobalt(II) fluoride; cobalt(III) fluoride; cobalt(II) hydroxide; cobalt(II) iodide; cobalt(II) nitrate; cobalt(II) oxalate; cobalt(II) perchlorate; cobalt(II) phosphate; cobalt(II) sulfate; cobalt(II) tetrafluoroborate; cobalt(II) thiocyanate; cobalt(II) thiocyanate; trans-dichlorobis(ethylenediamine)cobalt(III) chloride; Hexaamminecobalt(III) chloride; pentaamminechlorocobalt(III) chloride.

Nickel salts include: ammonium nickel(II) sulfate; bis(ethylenediamine)nickel(II) chloride; nickel(II) acetate; nickel(II) bromide; nickel(II) bromide ethylene glycol dimethyl ether complex; nickel(II) bromide 2-methoxyethyl ether complex; nickel carbonate, nickel(II) carbonate hydroxide; nickel (II) chloride; nickel(II) cyclohexanebutyrate; nickel (II) fluoride; nickel (II) hexafluorosilicate; nickel(II) hydroxide; nickel(II) iodide; nickel (II) nitrate; nickel(II) oxalate; nickel(II) perchlorate; nickel(II) sulfamate; nickel(II) sulfate; potassium nickel(IV) paraperiodate; potassium tetracyanonickelate (II).

Copper salts include: copper acetate, copper hexanoate, copper-2-ethylhexanoate copper carbonate; copper (II) acetylacetonate; copper(I) bromide; copper(II) bromide; copper(I) bromide dimethyl sulfide complex; copper(I) chloride; copper(II) chloride; copper(I) cyanide; copper(II) cyclohexanebutyrate; copper(II) fluoride; copper(II) formate; copper(II) D-gluconate; copper(II) hydroxide; copper(II) hydroxide phosphate; copper(I) iodide; copper(II) molybdate; copper(II) nitrate; copper(II) perchlorate; copper(II) pyrophosphate; copper(II) selenite; copper(II) sulfate; copper(II) tartrate; copper(II) tetrafluoroborate; copper(I) thiocyanate; tetraamminecopper(II) sulfate.

Zinc salts include: zinc bromide; zinc chloride; zinc citrate; zinc cyanide; zinc fluoride; zinc hexafluorosilicate; zinc iodide; zinc methacrylate; zinc molybdate; zinc nitrate; zinc oxalate; zinc perchlorate; zinc phosphate; zinc selenite; zinc sulfate; zinc tetrafluoroborate; zinc p-toluenesulfonate.

Silver salts include: silver bromate; silver carbonate; silver chlorate; silver chloride; silver chromate; silver citrate; silver cyanate; silver cyanide; silver cyclohexanebutyrate; silver(I) fluoride; silver(II) fluoride; silver heptafluorobutyrate; silver hexafluoroantimonate; silver hexafluoroarsenate(V); silver hexafluorophosphate; silver(I) hydrogenfluoride; silver iodide; silver lactate; silver metavanadate; silver molybdate; silver nitrate; silver nitrite; silver pentafluoropropionate; silver perchlorate; silver(I) perrhenate; silver phosphate; silver(I) sulfadiazine; silver sulfate; silver tetrafluoroborate; silver thiocyanate; silver p-toluenesulfonate.

Vanadium salts include: vanadium (III) acetylacetonate; vanadium(ll) chloride; vanadium(lll) chloride; vanadium(IV) chloride; vanadium(lll) chloride tetrahydrofuran complex; vanadium(V) oxychloride; vanadium(V) oxyfluoride.

Molybdenum salts include: Molybdenum(III) chloride; Molybdenum(V) chloride; Molybdenum(VI) dichloride dioxide.

Ruthenium salts include: chloropentaammineruthenium(ll) chloride; hexaammineruthenium(ll) chloride; hexaammineruthenium(lll) chloride; pentaamminechlororuthenium(lll) chloride; ruthenium(lll) chloride; ruthenium iodide; ruthenium(lll) nitrosyl chloride; ruthenium(lll) nitrosyl nitrate.

The transition metal salt may be selected from cobalt (II) naphthenate; copper carbonate; copper (II) acetylacetonate; silver nitrate; vanadium (III) acetylacetonate and combinations thereof.

Suitably, the transition metal is present in a mass fraction amount of from about 30 ppm to about 1000 ppm based on the total mass of the photocurable composition. For example, the transition metal may be present in a mass fraction amount of from about 50 ppm to about 750 ppm, preferably in an amount of from about 50 ppm to about 500 ppm, for example from about 100 ppm to about 500 ppm, or from about 150 ppm to about 500 ppm based on the total mass of the photocurable composition.

### Amine

Suitably, the photocurable composition comprises an amine. For example, the amine may be a trialkyl amine having the formula R₃N, where each R is a C₁-C₁₂ alkyl group.

R may be methyl, ethyl, propyl, butyl, pentyl, hexyl, heptyl, octyl, nonyl, decyl, undecyl, dodecyl or isomers thereof.

Suitably, R is ethyl, propyl, butyl, pentyl, hexyl or isomers thereof.

The amine may, for example, be selected from triethylamine, tripropylamine, tributylamine and trihexylamine.

The amine may be present in a mass fraction amount of from about 10 ppm to about 1000 ppm based on the total mass of the photocurable composition, suitably, the amine may be present in a mass fraction amount of from about 15 ppm to about 1000 ppm, for example from about 15 ppm to about 150 ppm, for example from about 15 ppm to 500 ppm, for example from about 20 ppm to about 1000 ppm, based on the total mass of the photocurable composition.

### Redox Curable Composition

The redox curable composition may comprise a (meth)acrylate adhesive composition. Suitably, the (meth)acrylate adhesive composition may comprise one or more (meth)acrylate components selected from among those that are a (meth)acrylate having the formula:

H₂C═CGCO₂R⁸,

where G may be hydrogen, halogen or alkyl groups having from 1 to about 4 carbon atoms, and R⁸ may be selected from alkyl, cycloalkyl, alkenyl, cycloalkenyl, alkaryl, aralkyl or aryl groups having from 1 to about 16 carbon atoms, any of which may be optionally substituted or interrupted as the case may be with silane, silicon, oxygen, halogen, carbonyl, hydroxyl, ester, carboxylic acid, urea, urethane, polyurethane, carbonate, amine, amide, sulfur, sulfonate, and sulfone.

One or more suitable (meth)acrylates may be chosen from among polyfunctional (meth)acrylates, such as, but not limited to, di-or tri-functional (meth)acrylates like polyethylene glycol di(meth)acrylates, tetrahydrofuran (meth)acrylates and di(meth)acrylates, hydroxypropyl (meth)acrylate (“HPMA”), hexanediol di(meth)acrylate, trimethylol propane tri(meth)acrylate (“TM PTMA”), diethylene glycol dimethacrylate, triethylene glycol dimethacrylate (“TRIEGMA”), tetraethylene glycol dimethacrylate, dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate, trimethylol propane triacrylate and bisphenol-A mono and di(meth)acrylates, such as ethoxylated bisphenol-A (meth)acrylate (“EBIPMA”), and bisphenol-F mono and di(meth)acrylates, such as ethoxylated bisphenol-F (meth)acrylate.

For example the anaerobically curable component may include Bisphenol A dimethacrylate:

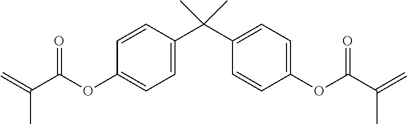 [SMILES: C=C(C)C(=O)Oc1ccc(C(C)(C)c2ccc(OC(=O)C(=C)C)cc2)cc1]

Still other (meth)acrylates that may be suitable for use herein are silicone (meth)acrylate moieties (“SiMA”), such as those taught by and claimed in U.S. Pat. No. 5,605,999 (Chu), the disclosure of which is hereby expressly incorporated herein by reference.

Other suitable materials may be chosen from polyacrylate esters represented by the formula:

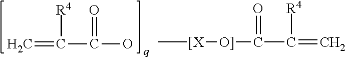

where R⁴ is a radical selected from hydrogen, halogen or alkyl of from 1 to about 4 carbon atoms; q is an integer equal to at least 1, and preferably equal to from 1 to about 4; and X is an organic radical containing at least two carbon atoms and having a total bonding capacity of q plus 1. With regard to the upper limit for the number of carbon atoms in X, workable monomers exist at essentially any value. As a practical matter, however, a general upper limit is about 50 carbon atoms, such as desirably about 30, and desirably about 20.

For example, X can be an organic radical of the formula:

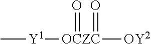

where each of Y¹ and Y² is an organic radical, such as a hydrocarbon group, containing at least 2 carbon atoms, and desirably from 2 to about 10 carbon atoms, and Z is an organic radical, preferably a hydrocarbon group, containing at least 1 carbon atom, and preferably from 2 to about 10 carbon atoms. Other materials may be chosen from the reaction products of di- or tri-alkylolamines (e.g., ethanolamines or propanolamines) with acrylic acids, such as are disclosed in French Pat. No. 1,581,361.

Suitable oligomers with (meth)acrylate functionality may also be used. Examples of such (meth)acrylate-functionalized oligomers include those having the following general formula:

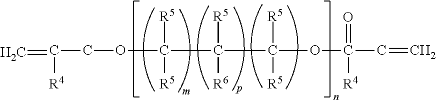

where R⁵ represents a radical selected from hydrogen, alkyl of from 1 to about 4 carbon atoms, hydroxy alkyl of from 1 to about 4 carbon atoms, or

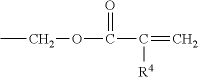

where R⁴ is a radical selected from hydrogen, halogen, or alkyl of from 1 to about 4 carbon atoms; R⁶ is a radical selected from hydrogen, hydroxyl, or

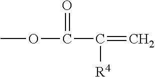

m is an integer equal to at least 1, e.g., from 1 to about 15 or higher, and desirably from 1 to about 8; n is an integer equal to at least 1, e.g., 1 to about 40 or more, and desirably between about 2 and about 10; and p is 0 or 1.

Typical examples of acrylic ester oligomers corresponding to the above general formula include di-, tri- and tetraethyleneglycol dimethacrylate; di(pentamethyleneglycol)dimethacrylate; tetraethyleneglycol diacrylate; tetraethyleneglycol di(chloroacrylate); diglycerol diacrylate; diglycerol tetramethacrylate; butyleneglycol dimethacrylate; neopentylglycol diacrylate; and trimethylolpropane triacrylate.

While di- and other polyacrylate esters, and particularly the polyacrylate esters described in the preceding paragraphs, can be desirable, monofunctional acrylate esters (esters containing one acrylate group) also may be used.

Suitable compounds can be chosen from among are cyclohexylmethacrylate, tetrahydrofurfuryl methacrylate, hydroxyethyl acrylate, hydroxypropyl methacrylate, t-butylaminoethyl methacrylate, cyanoethylacrylate, and chloroethyl methacrylate.

Another useful class of materials are the reaction product of (meth)acrylate-functionalized, hydroxyl- or amino-containing materials and polyisocyanate in suitable proportions so as to convert all of the isocyanate groups to urethane or ureido groups, respectively.

The so-formed (meth)acrylate urethane or urea esters may contain hydroxy or amino functional groups on the non-acrylate portion thereof. (Meth)acrylate esters suitable for use may be chosen from among those of the formula:

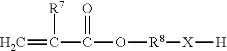

where X is selected from —O— and

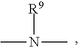

where R⁹ is selected from hydrogen or lower alkyl of 1 through 7 carbon atoms; R⁷ is selected from hydrogen, halogen (such as chlorine) or alkyl (such as methyl and ethyl radicals); and R⁸ is a divalent organic radical selected from alkylene of 1 through 8 carbon atoms, phenylene and naphthylene.

These groups upon proper reaction with a polyisocyanate, yield a monomer of the following general formula:

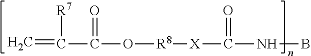

where n is an integer from 2 to about 6; B is a polyvalent organic radical selected from alkyl, alkenyl, cycloalkyl, cycloalkenyl, aryl, alkaryl, alkaryl and heterocyclic radicals both substituted and unsubstituted, and combinations thereof; and R⁷, R⁸ and X have the meanings given above.

Depending on the nature of B, these (meth)acrylate esters with urea or urethane linkages may have molecular weights placing them in the oligomer class (such as about 1,000 g/mol up to about 5,000 g/mol) or in the polymer class (such as about greater than 5,000 g/mol).

Other unsaturated reactive monomers and oligomers such as styrenes, maleimides, vinyl ethers, allyls, allyl ethers and those mentioned in US6844080B1 (Kneafsey et al.) can be used. Vinyl resins as mentioned in US6433091 (Xia) can also be used. Methacrylate or acrylate monomers containing these unsaturated reactive groups can also be used.

Of course, combinations of these (meth)acrylates and other monomers may also be used.

The redox curable composition may comprise one or more (meth)acrylate components as described above as part of an anaerobically curable composition.

Suitable commercial redox curable compositions include Loctite® 648 and Loctite® AA 326.

### EXAMPLES

Several standard lap shear samples were printed using a white rigid stereolithography (SLA)/digital light printing (DLP) three-dimensional printing resin—Loctite® 3D 3830. This is commercially available three-dimensional printing acrylate resin comprising (octahydro-4,7-methano-1H-indenediyl)bis(methylene) dicarylate (i.e. tricyclodecane dimethanol dimethacrylate).

Several resin formulations were prepared by adding transition metals in varying concentrations to Loctite® 3D 3830 i.e. Loctite® 3D 3830 was used as a base formulation (BF) to which transition metals were added. For example, a coper naphthenate stock solution was prepared having a concentration of 2000 ppm, as outlined in Table 1, and using said stock solutions, the formulations of Table 2 were prepared.

TABLE 1

| Component | (Amt/grams) |
|---|---|
| Copper naphthenate (8% in mineral oil) | 3 |
| BF | 117 |

TABLE 2

| | BF | Copper stock | Tributyl | Total Cu⁺ |
|---|---|---|---|---|
| | (Amt/ | solution | amine | concentration |
| Formulation | grams) | (Amt/grams) | (Amt/grams) | (ppm) |
| A | 187.5 | 62.5 | 0 | 500 |
| B | 218.75 | 31.25 | 0 | 250 |
| C | 237.5 | 12.5 | 0 | 100 |
| D | 243.75 | 6.25 | 0 | 50 |
| E | 243.75 | 6.25 | 5 × 10⁻³ | 50 |

Each formulation was mixed using an overhead stirrer and dispersed until a homogenous solution was obtained. Lap shear specimen (101.6 mm×25.4 mm×1.6 mm) were printed in accordance with ASTM 4587.

Two commercially available anaerobically curable adhesive compositions, Loctite® 648 and Loctite® AA 326, were employed to assess whether or not the incorporation of the transition metal into the three-dimensional printing resin, facilitated activation of the resulting cured resin. Printed lap shears were adhered to each other using the anaerobically curable adhesive and the fixture time of each of the adhesives on each of the three-dimensional printed articles was assessed.

Fixture times were evaluated with a gap of 0 mm between two printed laps shear substrates. Prior to application of adhesive each lap shear was wiped with isopropyl alcohol. Sufficient quantities of the adhesive composition were applied to the lap substrates to ensure complete coverage of a 322.6 mm² (0.5 in.²) bonding area. The two lap shears were mated and the drop or globule of adhesive was squeezed in the overlapping area creating a thin layer of adhesive between the lap shear specimen. Fixture time, which is defined as the minimum time required for the adhesive which is allowed to cure under ambient conditions to be able to support a suspended 3 kg mass (for 5 seconds) from one substrate whilst the other is clamped vertically, was evaluated for Loctite® 648 and Loctite® AA 326.

Fixture time was evaluated for each of the printed lap shears with Loctite® 648 and Loctite® AA 326. The results are provided in Table 3.

TABLE 3

| Lap shear printed | | | | |
|---|---|---|---|---|
| using three-dimensional | | | | |
| printing | Fixture Time | | | |
| resin formulation | Loctite ® 648 | | Loctite ® AA 326 | |
| BF (control) | >60 | minutes | >60 | minutes |
| A | 90 | seconds | 45 | seconds |
| B | 120 | seconds | 30 | seconds |
| C | 150 | seconds | 60 | seconds |
| D | 240 | seconds | 90 | seconds |
| E | 90 | seconds | 70 | seconds |
| BF (control 2)* | 45 | seconds | 10 | seconds |

*lap shear specimen treated with primer (Loctite ® SF 7649) before application of adhesive & mating of specimen

As is evident from Table 3, by incorporating a transition metal into the three-dimensional printing resin, the fixture time for a redox curable adhesive composition to a three-dimensional printed article formed using said resin, is significantly shorter than for substrates absent the transition metal. Furthermore, the inclusion of an amine in the three-dimensional printing resin, surprisingly further reduces fixture time. The results in Table 3 indicate that similar fixture times are achieved for the samples formed using a three-dimensional printing resin comprising a transition metal, as for bonding of three-dimensional printed lap shear specimen formed from the base formulation resin (absent a transition metal), where a primer was used to activate the bonding surfaces.

In addition, fixture times for Loctite® 648 and Loctite® AA 326 were assessed for the bonding of aluminium lap shear specimen (substrate 2) to lap shear specimen formed using the base formulation and the formulations of Table 2 (substrate 1). The results are provided in Table 4.

TABLE 4

| Substrate 1-lap | | | | |
|---|---|---|---|---|
| shear printed | | | | |
| using three-dimensional | Fixture Time** | | | |
| printing resin formulation: | Loctite ® 648 | | Loctite ® AA 326 | |
| BF (control) | >60 | minutes | >60 | minutes |
| A | 150 | seconds | 20 | seconds |
| B | 150 | seconds | 90 | seconds |
| C | 210 | seconds | 90 | seconds |
| D | 15 | minutes | 120 | seconds |
| E | 90 | seconds | 70 | seconds |
| BF (control 2)* | 45 | seconds | 10 | seconds |

*lap shear specimen treated with primer before application of adhesive & mating of specimen
**Substrate 2 is a bare aluminium lap shear specimen

The stability of each of the printing resin formulations was assessed to assess whether or not the addition of the transition metal or the amine affected storage stability.

The viscosity of each sample was measured before and after accelerated ageing and expressed as a ratio. The conditions of accelerated ageing were defined in terms of (a) temperature and (b) time. Viscosities were measured at 25° C., before and after ageing.

Initial viscosities were measured at 25° C. The sample was then aged by placing in an air circulating oven set at 82° C. for 72 hours. The viscosity after ageing was then determined at 25° C. The same conditions/apparatus for measuring viscosity were employed when measuring initial viscosity and viscosity after ageing.

The ratio of viscosities was then determined.

Viscosity Ratio=Viscosity after ageing (mPas)/Initial Viscosity (mPas)

A ratio of below 2 was considered a pass, indicating excellent shelf life at room temperature, a ratio of above 2 is considered a fail.

The results are provided in Table 5.

TABLE 5

| | Physical Properties | |
|---|---|---|
| | stability after 4 | stability after 72 |
| Formulation | hours at 82° C. | hours at 82° C. |
| BF | Pass | Pass |
| A | Pass | Pass |
| B | Pass | Pass |
| C | Pass | Pass |
| D | Pass | Pass |
| E | Pass | Pass |

Advantageously, the composition of the invention may be used to form three-dimensional printed articles, which may be bonded to other substrates without the need for additional primers.

While the prior art methods for activating plastic substrates involved using primers or impregnating the plastic substrate with a transition metal by melting and moulding the cured plastic substrate in the presence of a transition metal, the present invention provides a formulation comprising a curable composition which may be printed into complex three-dimensional printed articles, which comprises sufficient transition metal to facilitate bonding to other substrates without requiring the use of a primer.

The words “comprises/comprising” and the words “having/including” when used herein with reference to the present invention are used to specify the presence of stated features, integers, steps or components but do not preclude the presence or addition of one or more other features, integers, steps, components or groups thereof.

1) A method of bonding a substrate comprising a three-dimensional printed article to another substrate, the method comprising the steps of:
(a) providing a substrate comprising a three-dimensional printed article; wherein said three-dimensional printed article is formed by photocuring a photocurable composition comprising:
(i) a photopolymerizable component,
(ii) a photoinitiator, and
(iii) a transition metal;
(b) applying a redox curable composition to at least one of said substrates; and
(c) mating together the two substrates for a time sufficient for cure of the redox curable composition to take place.

2) The method of bonding according to claim 1, wherein the redox curable composition comprises a (meth)acrylate adhesive composition.

3) The method of bonding according to claim 1, wherein the redox curable composition comprises an anaerobically curable composition.

4) The method of bonding according to claim 1, wherein the transition metal is selected from copper, iron, vanadium, cobalt, chromium, silver, manganese and combinations thereof.

5) The method of bonding according to claim 1, wherein the transition metal is present in the form of a salt.

6) The method of bonding according to claim 1, wherein the transition metal is present in the photocurable composition in a mass fraction amount of from about 30 ppm to about 1000 ppm.

7) The method of bonding according to claim 6, wherein the transition metal is present in the photocurable composition in a mass fraction amount of from about 50 ppm to about 750 ppm.

8) The method of bonding according to claim 1, wherein the photocurable composition further comprises an amine component.

9) The method of bonding according to claim 8, wherein the amine component comprises a trialkyl amine.

10) The method of bonding according to claim 8, wherein the amine component is present in a mass fraction amount of from about 20 ppm to about 1000 ppm.

11) The method of bonding according to claim 1, wherein the photopolymerizable component comprises one or more (meth)acrylate monomer components.

12) The method of bonding according to claim 11, wherein the (meth)acrylate monomer has the formula: H2C═CGCO2R1, wherein G may be hydrogen, halogen or alkyl groups having from 1 to about 4 carbon atoms, and R1 may be selected from alkyl, cycloalkyl, alkenyl, cycloalkenyl, alkaryl, aralkyl or aryl groups having from 1 to about 16 carbon atoms, any of which may be optionally substituted or interrupted as the case may be with silane, silicon, oxygen, halogen, carbonyl, hydroxyl, ester, carboxylic acid, urea, urethane, polyurethane, carbonate, amine, amide, sulfur, sulfonate, and sulfone.

13) The method of bonding according to claim 1, wherein the time sufficient for cure of the redox curable composition is 15 minutes or less.

14) A photocurable composition comprising:
(i) a photopolymerizable component,
(ii) a photoinitiator,
(iii) a transition metal; and
(iv) an amine;
wherein the transition metal is present in a mass fraction amount of from about 30 ppm to about 1000 ppm based on the total mass of the photocurable composition; and wherein the amine is present in a mass fraction amount of from about 15 ppm to about 1000 ppm based on the total mass of the photocurable composition.

14. photocurable composition according to claim 14, wherein the amine is a trialkyl amine having the formula R3N, where each R is a C1-C12 alkyl group.

15. photocurable composition according to claim 15, wherein the trialkyl amine is selected from the group consisting of triethylamine, tripropylamine, tributylamine, tripentylamine, and trihexylamine.
